(19) United States
(12) Patent Application Publication
(10) Pub. No.: US 2018/0191407 A1
(43) Pub. Date: Jul. 5, 2018

(54) INFORMATION TRANSMISSION METHOD, APPARATUS, AND DEVICE

(71) Applicant: HUAWEI TECHNOLOGIES CO., LTD., Shenzhen (CN)

(72) Inventors: Peng ZHANG, Shanghai (CN); Yueying ZHAO, Shanghai (CN)

(73) Assignee: HUAWEI TECHNOLOGIES CO., LTD., Shenzhen (CN)

(21) Appl. No.: 15/906,742

(22) Filed: Feb. 27, 2018

Related U.S. Application Data
(63) Continuation of application No. PCT/CN2015/088326, filed on Feb. 28, 2015.

(51) Int. Cl. H04B 7/04

(52) U.S. Cl. CPC H04B 7/046; H04W 76/27

(57) ABSTRACT

The present disclosure relates to an information transmission method, apparatus, and device, the UE can neither correctly receive a signal from a serving cell nor effectively cancel or suppress interference caused by a signal from a neighboring cell. The information transmission method provided in embodiments of the present application includes: determining, by a network-side device, virtual antenna mapping (VAM) matrix information of at least one cell sending a multiple-input multiple-output (MIMO) signal, and informing user equipment (UE) of the VAM matrix information of the at least one cell. According to the embodiments of the present application, UE may correctly demodulate a MIMO signal received from a serving cell, and may further cancel or suppress interference from a neighboring cell by demodulating a MIMO signal from the neighboring cell.

### CROSS-REFERENCE TO RELATED APPLICATIONS

This application is a continuation of International Application No. PCT/CN2015/088326, filed on Aug. 28, 2015, the disclosure of which is hereby incorporated by reference in its entirety.

### TECHNICAL FIELD

The present disclosure relates to the field of wireless communications technologies, and in particular, to an information transmission method, apparatus, and device.

### BACKGROUND

In a wideband code division multiple access (WCDMA) system, to increase a data transmission rate of user equipment (UE) and increase a signal to interference plus noise ratio of a signal received by cell-edge UE, a cell may configure a downlink multiple-input multiple-output (MIMO) transmission manner for the UE.

When the UE is located in a serving cell, if the serving cell transmits a MIMO signal, the UE needs to know precoding information (PCI) used by the cell to correctly demodulate the MIMO signal.

When the UE is in an edge area between a serving cell and a neighboring cell, the UE may receive an interference signal from the neighboring cell. To improve quality of a signal received from the serving cell, the UE may process interference from the neighboring cell. Processing manners include interference cancellation, interference suppression, and the like. For the MIMO interference signal, the UE needs to know PCI used by the MIMO interference signal, so as to perform an operation of interference cancellation or interference suppression. If the UE does not know the PCI used by the MIMO interference signal, the UE cannot correctly model the MIMO interference signal, and consequently an effect of performing interference cancellation or interference suppression is poor.

When a cell sends a pilot signal used for channel estimation, the cell needs to precode the pilot signal based on a virtual antenna mapping (VAM) matrix. As shown in FIG. 1, assuming that a primary pilot signal is P0, a secondary pilot signal is P1, a data stream 1 signal is x1, a data stream 2 signal is x2, a VAM matrix is S, a matrix for precoding the data stream signals is B, where B is any matrix in a known precoding matrix group, and a channel matrix is H, received signals y1 and y2 that are on a UE side and that correspond to the primary pilot signal P0 and the secondary pilot signal P₁ in FIG. 2 may be expressed as:

$$[ \begin{matrix}{y}_{1} \\ {y}_{2}\end{matrix} ] = HS [ \begin{matrix}{P}_{0} \\ {P}_{1}\end{matrix} ] \qquad ( 1 )$$

It can be learned that the UE may obtain HS based on the known received signals y₁ and y₂ and the known transmitted pilot signals P₀ and P₁.

Received signals z₁ and z₂ that are on the UE side and that correspond to the data stream signals x₁ and x₂ in FIG. 2 may be expressed as:

$$\begin{matrix}[ \begin{matrix}{z}_{1} \\ {z}_{2}\end{matrix} ] = HB [ \begin{matrix}{x}_{1} \\ {x}_{2}\end{matrix} ] & ( 2 ) \\ [ \begin{matrix}{z}_{1} \\ {z}_{2}\end{matrix} ] = {HBx}_{1} & ( 3 )\end{matrix}$$

Formula (2) corresponds to two transmitted data stream signals, and formula (3) corresponds to one transmitted data stream signal. It can be learned that the UE needs to know H to correctly demodulate x1 and x2. However, according to the received pilot signals, the UE can only estimate HS. Apparently, the UE cannot correctly demodulate the data stream signals.

As shown in FIG. 2, FIG. 2 shows another MIMO transmission manner. In this transmission manner, pilot signals are transmitted in the transmission manner shown in formula (1). Data stream signals are respectively precoded by using S⁻¹B and HS that can be estimated based on the pilot signals, as shown in the following formulas:

$$\begin{matrix}[ \begin{matrix}{z}_{1} \\ {z}_{2}\end{matrix} ] = {HSS}^{- 1} B [ \begin{matrix}{x}_{1} \\ {x}_{2}\end{matrix} ] & ( 4 ) \\ [ \begin{matrix}{z}_{1} \\ {z}_{2}\end{matrix} ] = {HSS}^{- 1} {Bx}_{1} & ( 5 )\end{matrix}$$

Formula (4) corresponds to two transmitted data stream signals, and formula (5) corresponds to one transmitted data stream signal. It can be learned that to correctly demodulate x1 and x2, the UE not only needs to estimate HS based on the pilot signals, but also needs to know S−1B. The UE cannot correctly demodulate the data stream signals if the UE does not know S−1B.

In conclusion, in the MIMO transmission manner of WCDMA, UE cannot correctly demodulate a data stream signal. Consequently, the UE can neither correctly receive a signal from a serving cell nor effectively cancel or suppress interference caused by a signal from a neighboring cell.

### SUMMARY

Embodiments of the present application provide an information transmission method, apparatus, and device, so as to resolve a problem that because UE cannot correctly demodulate a MIMO signal, the UE can neither correctly receive a signal from a serving cell nor effectively cancel or suppress interference caused by a signal from a neighboring cell.

According to a first aspect, an information transmission apparatus is provided, including:
a determining module, configured to: determine virtual antenna mapping (VAM) matrix information of at least one cell sending a multiple-input multiple-output (MIMO) signal, and transmit the determined VAM matrix information of the at least one cell to a sending module; and
the sending module, configured to inform user equipment (UE) of the VAM matrix information that is of the at least one cell and that is determined by the determining module.

With reference to the first aspect, in a first possible implementation, if the apparatus is in a radio network controller (RNC), the determining module is configured to determine VAM matrix information of a cell covered by at least one base station that is managed by the RNC, and/or determine VAM matrix information of a cell covered by at least one base station that is managed by another RNC.

With reference to the first possible implementation of the first aspect, in a second possible implementation, the determining module is configured to determine the VAM matrix information of the cell covered by the at least one base station that is managed by the RNC according to the following step: receiving the VAM matrix information that is of the cell and that is respectively sent from the at least one base station; or respectively configuring the VAM matrix information for the cell covered by the at least one base station that is managed by the RNC.

With reference to the second possible implementation of the first aspect, in a third possible implementation, the sending module is further configured to after the determining module respectively configures the VAM matrix information for the cell covered by the at least one base station that is managed by the RNC, send the VAM matrix information configured for each cell to a base station to which the cell belongs.

With reference to the first possible implementation of the first aspect, in a fourth possible implementation, the determining module is configured to determine the VAM matrix information of the cell covered by the at least one base station that is managed by the another RNC according to the following step: receiving the VAM matrix information that is of the cell and that is sent from the another RNC.

With reference to any one of the first aspect, or the first to the fourth possible implementations of the first aspect, in a fifth possible implementation, if the apparatus is in a radio network controller (RNC), the sending module is configured to inform the UE of the VAM matrix information of the at least one cell by using radio resource control (RRC) signaling.

With reference to the first aspect, in a sixth possible implementation, if the apparatus is in a base station, the determining module is configured to: obtain the VAM matrix information that is of the at least one cell and that is configured by a radio network controller (RNC); or configure VAM matrix information for at least one cell covered by the base station, and obtain VAM matrix information that is of at least one cell and that is configured by another base station.

With reference to the first aspect, or the sixth possible implementation of the first aspect, in a seventh possible implementation, if the apparatus is in a base station, the sending module is configured to inform the user equipment (UE) of the VAM matrix information of the at least one cell by using physical layer signaling, where the physical layer signaling includes broadcast signaling or dedicated control signaling.

With reference to the seventh possible implementation of the first aspect, in an eighth possible implementation, if the base station is a serving base station, the at least one cell includes a serving cell and a neighboring cell of the UE; or if the base station is a neighboring base station, the at least one cell includes at least one cell covered by the neighboring base station.

With reference to any one of the first aspect, or the first to the eighth possible implementations of the first aspect, in a ninth possible implementation, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

With reference to the ninth possible implementation of the first aspect, in a tenth possible implementation, the information for indicating a VAM matrix used by the cell includes one or more of the following information: identification information for indicating the VAM matrix; identification information for indicating a phase used by the VAM matrix; or identification information of the cell.

With reference to the ninth possible implementation of the first aspect, in an eleventh possible implementation, the information for indicating a precoding codebook group used by the cell includes one or more of the following information: identification information of the precoding codebook group; information about the VAM matrix used to generate the precoding codebook group; or identification information of the cell.

According to a second aspect, an information transmission apparatus is provided, including:
a receiving module, configured to: receive virtual antenna mapping (VAM) matrix information that is of at least one cell and that is sent from a network-side device, and transmit the received VAM matrix information of the at least one cell to a demodulation module; and
the demodulation module, configured to demodulate, based on VAM matrix information of any one of the at least one cell, a multiple-input multiple-output (MIMO) signal received from the cell.

With reference to the second aspect, in a first possible implementation, if the apparatus is in a radio network controller (RNC), the receiving module is configured to receive the VAM matrix information that is of the at least one cell and that is sent from the RNC by using radio resource control (RRC) signaling.

With reference to the second aspect, in a second possible implementation, if the apparatus is in a base station, the receiving module is configured to receive the VAM matrix information that is of the at least one cell and that is sent from the base station by using physical layer signaling, where the physical layer signaling includes broadcast signaling or dedicated control signaling.

With reference to the second possible implementation of the second aspect, in a third possible implementation, if the base station is a serving base station, the at least one cell includes a serving cell and a neighboring cell of UE; or if the base station is a neighboring base station, the at least one cell includes at least one cell covered by the neighboring base station.

With reference to any one of the second aspect, or the first to the third possible implementation of the second aspect, in a fourth possible implementation, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

With reference to the fourth possible implementation of the second aspect, in a fifth possible implementation, the information for indicating a VAM matrix used by the cell includes one or more of the following information: identification information for indicating the VAM matrix; identification information for indicating a phase used by the VAM matrix; or identification information of the cell.

With reference to the fourth possible implementation of the second aspect, in a sixth possible implementation, the information for indicating a precoding codebook group used by the cell includes one or more of the following information: identification information of the precoding codebook group; information about the VAM matrix used to generate the precoding codebook group; or identification information of the cell.

According to a third aspect, an information transmission device is provided, including:
a processor, configured to: determine virtual antenna mapping (VAM) matrix information of at least one cell sending a multiple-input multiple-output (MIMO) signal, and transmit the determined VAM matrix information of the at least one cell to a transmitter; and
the transmitter, configured to inform user equipment (UE) of the VAM matrix information that is of the at least one cell and that is determined by the processor.

With reference to the third aspect, in a first possible implementation, if the device is a radio network controller (RNC), the processor is configured to determine VAM matrix information of a cell covered by at least one base station that is managed by the RNC, and/or determine VAM matrix information of a cell covered by at least one base station that is managed by another RNC.

With reference to the first possible implementation of the third aspect, in a second possible implementation, the processor is configured to determine the VAM matrix information of the cell covered by the at least one base station that is managed by the RNC according to the following step: determining the VAM matrix information that is of the cell and that is respectively sent from the at least one base station to the RNC; or respectively configuring the VAM matrix information for the cell covered by the at least one base station that is managed by the RNC.

With reference to the second possible implementation of the third aspect, in a third possible implementation, the transmitter is further configured to after the processor respectively configures the VAM matrix information for the cell covered by the at least one base station that is managed by the RNC, send the VAM matrix information configured for each cell to a base station to which the cell belongs.

With reference to the first possible implementation of the third aspect, in a fourth possible implementation, the processor is configured to determine the VAM matrix information of the cell covered by the at least one base station that is managed by the another RNC according to the following step determining the VAM matrix information that is of the cell and that is sent from the another RNC.

With reference to any one of the third aspect, or the first to the fourth possible implementations of the third aspect, in a fifth possible implementation, if the device is a radio network controller (RNC), the transmitter is configured to inform the UE of the VAM matrix information of the at least one cell by using radio resource control (RRC) signaling.

With reference to the third aspect, in a sixth possible implementation, if the device is a base station, the processor is configured to: obtain the VAM matrix information that is of the at least one cell and that is configured by a radio network controller (RNC); or configure VAM matrix information for at least one cell covered by the base station, and obtain VAM matrix information that is of at least one cell and that is configured by another base station.

With reference to the third aspect, or the sixth possible implementation of the third aspect, in a seventh possible implementation, if the device is a base station, the transmitter is configured to inform the user equipment (UE) of the VAM matrix information of the at least one cell by using physical layer signaling, where the physical layer signaling includes broadcast signaling or dedicated control signaling.

With reference to the seventh possible implementation of the third aspect, in an eighth possible implementation, if the base station is a serving base station, the at least one cell includes a serving cell and a neighboring cell of the UE; or if the base station is a neighboring base station, the at least one cell includes at least one cell covered by the neighboring base station.

With reference to any one of the third aspect, or the first to the eighth possible implementations of the third aspect, in a ninth possible implementation, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

With reference to the ninth possible implementation of the third aspect, in a tenth possible implementation, the information for indicating a VAM matrix used by the cell includes one or more of the following information: identification information for indicating the VAM matrix; identification information for indicating a phase used by the VAM matrix; or identification information of the cell.

With reference to the ninth possible implementation of the third aspect, in an eleventh possible implementation, the information for indicating a precoding codebook group used by the cell includes one or more of the following information: identification information of the precoding codebook group; information about the VAM matrix used to generate the precoding codebook group; or identification information of the cell.

According to a fourth aspect, an information transmission device is provided, including:
a receiver, configured to: receive virtual antenna mapping (VAM) matrix information that is of at least one cell and that is sent from a network-side device, and transmit the received VAM matrix information of the at least one cell to a processor; and
the processor, configured to demodulate, based on VAM matrix information of any one of the at least one cell, a multiple-input multiple-output (MIMO) signal received from the cell.

With reference to the fourth aspect, in a first possible implementation, if the device is a radio network controller (RNC), the receiver is configured to receive the VAM matrix information that is of the at least one cell and that is sent from the RNC by using radio resource control (RRC) signaling.

With reference to the fourth aspect, in a second possible implementation, if the device is a base station, the receiver is configured to receive the VAM matrix information that is of the at least one cell and that is sent from the base station by using physical layer signaling, where the physical layer signaling includes broadcast signaling or dedicated control signaling.

With reference to the second possible implementation of the fourth aspect, in a third possible implementation, if the base station is a serving base station, the at least one cell includes a serving cell and a neighboring cell of UE; or if the base station is a neighboring base station, the at least one cell includes at least one cell covered by the neighboring base station.

With reference to any one of the fourth aspect, or the first to the third possible implementation of the fourth aspect, in a fourth possible implementation, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

With reference to the fourth possible implementation of the fourth aspect, in a fifth possible implementation, the information for indicating a VAM matrix used by the cell includes one or more of the following information: identification information for indicating the VAM matrix; identification information for indicating a phase used by the VAM matrix; or identification information of the cell.

With reference to the fourth possible implementation of the fourth aspect, in a sixth possible implementation, the information for indicating a precoding codebook group used by the cell includes one or more of the following information: identification information of the precoding codebook group; information about the VAM matrix used to generate the precoding codebook group; or identification information of the cell.

According to a fifth aspect, an information transmission method is provided, including:
determining, by a network-side device, virtual antenna mapping (VAM) matrix information of at least one cell sending a multiple-input multiple-output (MIMO) signal; and
informing, by the network-side device, user equipment (UE) of the VAM matrix information of the at least one cell.

With reference to the fifth aspect, in a first possible implementation, if the network-side device is a radio network controller (RNC), the determining, by the RNC, VAM matrix information of at least one cell sending a MIMO signal includes: determining, by the RNC, VAM matrix information of a cell covered by at least one base station that is managed by the RNC, and/or determining, by the RNC, VAM matrix information of a cell covered by at least one base station that is managed by another RNC.

With reference to the first possible implementation of the fifth aspect, in a second possible implementation, the determining, by the RNC, VAM matrix information of a cell covered by at least one base station that is managed by the RNC includes: receiving, by the RNC, the VAM matrix information that is of the cell and that is respectively sent from the at least one base station; or respectively configuring, by the RNC, the VAM matrix information for the cell covered by the at least one base station that is managed by the RNC.

With reference to the second possible implementation of the fifth aspect, in a third possible implementation, after the respectively configuring, by the RNC, the VAM matrix information for the cell covered by the at least one base station that is managed by the RNC, the method further includes sending, by the RNC, the VAM matrix information configured for each cell to a base station to which the cell belongs.

With reference to the first possible implementation of the fifth aspect, in a fourth possible implementation, the determining, by the RNC, VAM matrix information of a cell covered by at least one base station that is managed by another RNC includes receiving, by the RNC, the VAM matrix information that is of the cell and that is sent from the another RNC.

With reference to any one of the fifth aspect, or the first to the fourth possible implementations of the fifth aspect, in a fifth possible implementation, if the network-side device is a radio network controller (RNC), the informing, by the RNC, UE of the VAM matrix information of the at least one cell includes informing, by the RNC, the UE of the VAM matrix information of the at least one cell by using radio resource control (RRC) signaling.

With reference to the fifth aspect, in a sixth possible implementation, if the network-side device is a base station, the determining, by the base station, VAM matrix information of at least one cell sending a MIMO signal includes obtaining, by the base station, the VAM matrix information that is of the at least one cell and that is configured by a radio network controller (RNC); or configuring, by the base station, VAM matrix information for at least one cell covered by the base station, and obtaining VAM matrix information that is of at least one cell and that is configured by another base station.

With reference to the fifth aspect, or the sixth possible implementation of the fifth aspect, in a seventh possible implementation, if the network-side device is a base station, the informing, by the base station, UE of the VAM matrix information of the at least one cell includes informing, by the base station, the user equipment (UE) of the VAM matrix information of the at least one cell by using physical layer signaling, where the physical layer signaling includes broadcast signaling or dedicated control signaling.

With reference to the seventh possible implementation of the fifth aspect, in an eighth possible implementation, if the base station is a serving base station, the at least one cell includes a serving cell and a neighboring cell of the UE; or if the base station is a neighboring base station, the at least one cell includes at least one cell covered by the neighboring base station.

With reference to any one of the fifth aspect, or the first to the eighth possible implementations of the fifth aspect, in a ninth possible implementation, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

With reference to the ninth possible implementation of the fifth aspect, in a tenth possible implementation, the information for indicating a VAM matrix used by the cell includes one or more of the following information: identification information for indicating the VAM matrix; identification information for indicating a phase used by the VAM matrix; or identification information of the cell.

With reference to the ninth possible implementation of the fifth aspect, in an eleventh possible implementation, the information for indicating a precoding codebook group used by the cell includes one or more of the following information: identification information of the precoding codebook group; information about the VAM matrix used to generate the precoding codebook group; or identification information of the cell.

According to a sixth aspect, an information transmission method is provided, including:
receiving, by user equipment (UE), virtual antenna mapping (VAM) matrix information that is of at least one cell and that is sent from a network-side device; and
demodulating, by the UE, based on VAM matrix information of any one of the at least one cell, a multiple-input multiple-output (MIMO) signal received from the cell.

With reference to the sixth aspect, in a first possible implementation, if the network-side device is a radio network controller (RNC), the receiving, by UE, VAM matrix information that is of at least one cell and that is sent from the RNC includes receiving, by the UE, the VAM matrix information that is of the at least one cell and that is sent from the RNC by using radio resource control (RRC) signaling.

With reference to the sixth aspect, in a second possible implementation, if the network-side device is a base station, the receiving, by UE, VAM matrix information that is of at least one cell and that is sent from the base station includes receiving, by the UE, the VAM matrix information that is of the at least one cell and that is sent from the base station by using physical layer signaling, where the physical layer signaling includes broadcast signaling or dedicated control signaling.

With reference to the second possible implementation of the sixth aspect, in a third possible implementation, if the base station is a serving base station, the at least one cell includes a serving cell and a neighboring cell of the UE; or if the base station is a neighboring base station, the at least one cell includes at least one cell covered by the neighboring base station.

With reference to any one of the sixth aspect, or the first to the third possible implementation of the sixth aspect, in a fourth possible implementation, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

With reference to the fourth possible implementation of the sixth aspect, in a fifth possible implementation, the information for indicating a VAM matrix used by the cell includes one or more of the following information: identification information for indicating the VAM matrix; identification information for indicating a phase used by the VAM matrix; or identification information of the cell.

With reference to the fourth possible implementation of the sixth aspect, in a sixth possible implementation, the information for indicating a precoding codebook group used by the cell includes one or more of the following information: identification information of the precoding codebook group; information about the VAM matrix used to generate the precoding codebook group; or identification information of the cell.

According to the method, apparatus, or device according to any one of the foregoing aspects, the network-side device may inform the UE of the determined VAM matrix information of the at least one cell sending the MIMO signal, and the UE may demodulate, based on VAM matrix information of a cell, a multiple-input multiple-output (MIMO) signal received from the cell. It can be learned that, based on the foregoing method, apparatus, or device, when the at least one cell includes a serving cell, the UE may correctly demodulate a MIMO signal received from the serving cell, and when the at least one cell includes a neighboring cell, the UE may cancel or suppress interference from the neighboring cell by demodulating a MIMO signal from the neighboring cell.

### BRIEF DESCRIPTION OF DRAWINGS

FIG. 1 shows a first MIMO signal transmission manner;

FIG. 2 shows a second MIMO signal transmission manner;

FIG. 3 is a schematic structural diagram of an information transmission system 30 according to an embodiment of the present application;

FIG. 4 is a schematic structural diagram of an information transmission apparatus according to an embodiment of the present application;

FIG. 5 is a schematic structural diagram of another information transmission apparatus according to an embodiment of the present application;

FIG. 6 is a schematic structural diagram of an information transmission device according to an embodiment of the present application;

FIG. 7 is a schematic structural diagram of another information transmission device according to an embodiment of the present application;

FIG. 8 is a flowchart of an information transmission method according to an embodiment of the present application;

FIG. 9 is a flowchart of an information transmission method according to another embodiment of the present application;

FIG. 10 is a flowchart of an information transmission method according to still another embodiment of the present application;

FIG. 11 is a flowchart of an information transmission method according to yet another embodiment of the present application; and

FIG. 12 is a flowchart of an information transmission method according to still yet another embodiment of the present application.

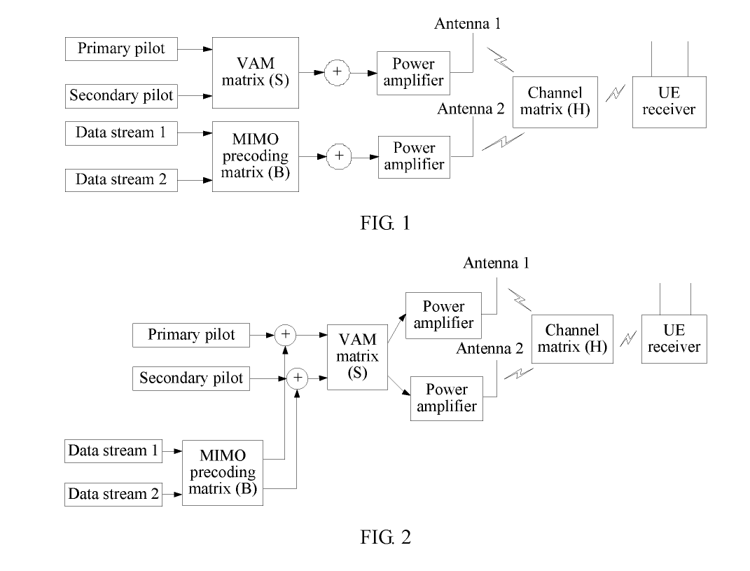

### DESCRIPTION OF EMBODIMENTS

To make the objectives, technical solutions, and advantages of the present application clearer, the following further describes the present application in detail with reference to the accompanying drawings. Apparently, the described embodiments are merely some but not all of the embodiments of the present application. All other embodiments obtained by a person of ordinary skill in the art based on the embodiments of the present application without creative efforts shall fall within the protection scope of the present application.

The technical solutions described in the embodiments of the present application may be applied to a wideband code division multiple access (WCDMA) communications system or a high speed packet access (HSPA) communications system.

In the embodiments of the present application, various aspects of the technical solutions are described from the perspective of user equipment and/or a network-side device.

The user equipment may be a wireless terminal or a wired terminal. The wireless terminal may refer to a device that provides a user with voice and/or data connectivity, a handheld device with a radio connection function, or another processing device connected to a radio modem. The wireless terminal may communicate with one or more core networks through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile device, which exchanges voice and/or data with the radio access network. For example, it may be a device such as a personal communication service (PCS) phone, a cordless telephone set, a Session Initiation Protocol (SIP) phone, a wireless local loop (WLL) station, or a personal digital assistant (PDA). The wireless terminal may also be referred to as a system, a subscriber unit, a subscriber station, a mobile station, a mobile terminal, a remote station, an access point, a remote terminal, an access terminal, a user terminal, a user agent, a user device, or user equipment.

The network-side device in the embodiments of the present application may be a radio network controller (RNC) or a base station, and is further described below.

The term “and/or” in the embodiments of the present application describes only an association relationship for describing associated objects and represents that three relationships may exist. For example, A and/or B may represent the following three cases: Only A exists, both A and B exist, and only B exists.

In the embodiments of the present application, the network-side device determines VAM matrix information of at least one cell sending a MIMO signal and informs UE of the VAM matrix information of the at least one cell. The UE may demodulate, based on VAM matrix information of any one of the at least one cell, a multiple-input multiple-output (MIMO) signal received from the cell. According to the embodiments of the present application, UE may correctly demodulate a MIMO signal received from a serving cell, and may further cancel or suppress interference from a neighboring cell by demodulating a MIMO signal from the neighboring cell.

The following further describes the embodiments of the present application in detail with reference to the accompanying drawings of this specification.

An information transmission system, an information transmission apparatus, an information transmission device, and an information transmission method provided in the following embodiments of the present application are based on a same application concept, and principles used for resolving problems in the system, the apparatus, and the device are similar to a principle used for resolving problems in the information transmission method in the embodiments of the present application. Therefore, for implementation of the system, the apparatus, and the device, refer to implementation of the method, and repetitions are not described herein.

As shown in FIG. 3, FIG. 3 is a schematic structural diagram of an information transmission system 30 according to an embodiment of the present application. The information transmission system 30 includes: a network-side device 31, configured to: determine virtual antenna mapping (VAM) matrix information of at least one cell sending a multiple-input multiple-output (MIMO) signal, and inform user equipment (UE) of the VAM matrix information of the at least one cell; and the user equipment (UE) 32, configured to: receive the virtual antenna mapping (VAM) matrix information that is of at least one cell and that is sent from the network-side device, and demodulate, based on VAM matrix information of any one of the at least one cell, a multiple-input multiple-output (MIMO) signal received from the cell.

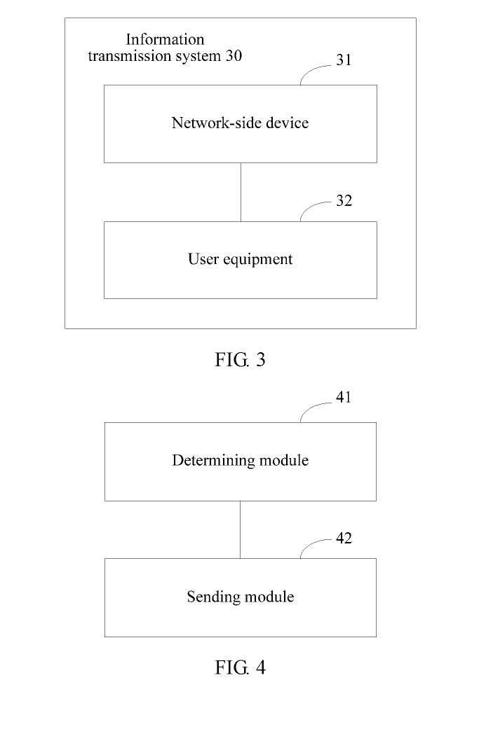

As shown in FIG. 4, an embodiment of the present application further provides an information transmission apparatus. The information transmission apparatus may be deployed in a radio network controller (RNC), a base station, or a network device controlled by the RNC or the base station. The information transmission apparatus includes: a determining module 41, configured to: determine virtual antenna mapping (VAM) matrix information of at least one cell sending a multiple-input multiple-output (MIMO) signal, and transmit the determined VAM matrix information of the at least one cell to a sending module; and the sending module 42, configured to inform user equipment (UE) of the VAM matrix information that is of the at least one cell and that is determined by the determining module 41.

Optionally, if the apparatus is in a radio network controller (RNC), the determining module 41 is configured to determine VAM matrix information of a cell covered by at least one base station that is managed by the RNC, and/or determine VAM matrix information of a cell covered by at least one base station that is managed by another RNC.

Optionally, the determining module 41 is configured to determine the VAM matrix information of the cell covered by the at least one base station that is managed by the RNC according to the following step: receiving the VAM matrix information that is of the cell and that is respectively sent from the at least one base station; or respectively configuring the VAM matrix information for the cell covered by the at least one base station that is managed by the RNC.

Optionally, the sending module 42 is further configured to after the determining module respectively configures the VAM matrix information for the cell covered by the at least one base station that is managed by the RNC, send the VAM matrix information configured for each cell to a base station to which the cell belongs.

Optionally, the determining module 41 is configured to determine the VAM matrix information of the cell covered by the at least one base station that is managed by the another RNC according to the following step: receiving the VAM matrix information that is of the cell and that is sent from the another RNC.

Optionally, if the apparatus is in a radio network controller (RNC), the sending module 42 is configured to inform the UE of the VAM matrix information of the at least one cell by using radio resource control (RRC) signaling.

Optionally, if the apparatus is in a base station, the determining module 41 is configured to: obtain the VAM matrix information that is of the at least one cell and that is configured by a radio network controller (RNC); or configure VAM matrix information for at least one cell covered by the base station, and obtain VAM matrix information that is of at least one cell and that is configured by another base station.

Optionally, if the apparatus is in a base station, the sending module 42 is configured to inform the user equipment (UE) of the VAM matrix information of the at least one cell by using physical layer signaling, where the physical layer signaling includes broadcast signaling or dedicated control signaling.

Optionally, if the base station is a serving base station, the at least one cell includes a serving cell and a neighboring cell of the UE; or if the base station is a neighboring base station, the at least one cell includes at least one cell covered by the neighboring base station.

Optionally, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

Optionally, the information for indicating a VAM matrix used by the cell includes one or more of the following information: identification information for indicating the VAM matrix; identification information for indicating a phase used by the VAM matrix; or identification information of the cell.

Optionally, the information for indicating a precoding codebook group used by the cell includes one or more of the following information: identification information of the precoding codebook group; information about the VAM matrix used to generate the precoding codebook group; or identification information of the cell.

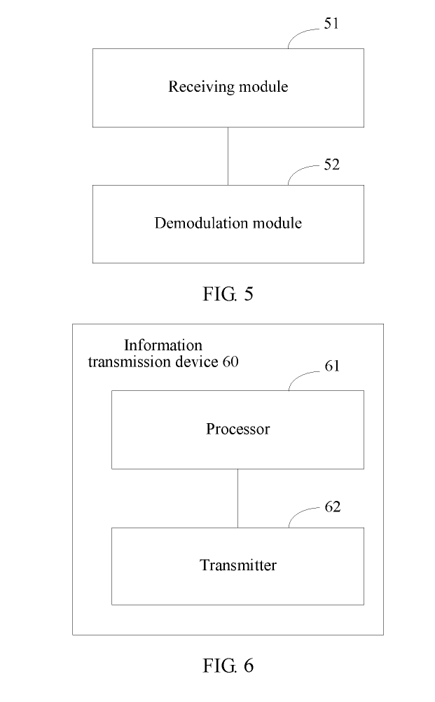

Corresponding to the information transmission apparatus in FIG. 4, as shown in FIG. 5, an embodiment of the present application further provides another information transmission apparatus. The information transmission apparatus may be deployed in UE and includes: a receiving module 51, configured to: receive virtual antenna mapping (VAM) matrix information that is of at least one cell and that is sent from a network-side device, and transmit the received VAM matrix information of the at least one cell to a demodulation module; and the demodulation module 52, configured to demodulate, based on VAM matrix information of any one of the at least one cell, a multiple-input multiple-output (MIMO) signal received from the cell.

Optionally, if the apparatus is in a radio network controller (RNC), the receiving module 51 is configured to receive the VAM matrix information that is of the at least one cell and that is sent from the RNC by using radio resource control (RRC) signaling.

Optionally, if the apparatus is in a base station, the receiving module 51 is configured to receive the VAM matrix information that is of the at least one cell and that is sent from the base station by using physical layer signaling, where the physical layer signaling includes broadcast signaling or dedicated control signaling.

Optionally, if the base station is a serving base station, the at least one cell includes a serving cell and a neighboring cell of the UE; or if the base station is a neighboring base station, the at least one cell includes at least one cell covered by the neighboring base station.

Optionally, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

Optionally, the information for indicating a VAM matrix used by the cell includes one or more of the following information: identification information for indicating the VAM matrix; identification information for indicating a phase used by the VAM matrix; or identification information of the cell.

Optionally, the information for indicating a precoding codebook group used by the cell includes one or more of the following information: identification information of the precoding codebook group; information about the VAM matrix used to generate the precoding codebook group; or identification information of the cell.

As shown in FIG. 6, FIG. 6 shows an information transmission device 60 according to an embodiment of the present application. The device may be a radio network controller (RNC) or a base station, and includes: a processor 61, configured to: determine virtual antenna mapping (VAM) matrix information of at least one cell sending a multiple-input multiple-output (MIMO) signal, and transmit the determined VAM matrix information of the at least one cell to a transmitter; and the transmitter 62, configured to inform user equipment (UE) of the VAM matrix information that is of the at least one cell and that is determined by the processor 61.

Optionally, if the device is a radio network controller (RNC), the processor 61 is configured to determine VAM matrix information of a cell covered by at least one base station that is managed by the RNC, and/or determine VAM matrix information of a cell covered by at least one base station that is managed by another RNC.

Optionally, the processor 61 is configured to determine the VAM matrix information of the cell covered by the at least one base station that is managed by the RNC according to the following step: determining the VAM matrix information that is of the cell and that is respectively sent from the at least one base station to the RNC; or respectively configuring the VAM matrix information for the cell covered by the at least one base station that is managed by the RNC.

Optionally, the transmitter 62 is further configured to, after the processor 61 respectively configures the VAM matrix information for the cell covered by the at least one base station that is managed by the RNC, send the VAM matrix information configured for each cell to a base station to which the cell belongs.

Optionally, the processor 61 is configured to determine the VAM matrix information of the cell covered by the at least one base station that is managed by the another RNC according to the following step: determining the VAM matrix information that is of the cell and that is sent from the another RNC.

Optionally, if the device is a radio network controller (RNC), the transmitter 62 is configured to inform the UE of the VAM matrix information of the at least one cell by using radio resource control (RRC) signaling.

Optionally, if the device is a base station, the processor 61 is configured to obtain the VAM matrix information that is of the at least one cell and that is configured by a radio network controller (RNC); or configure VAM matrix information for at least one cell covered by the base station, and obtain VAM matrix information that is of at least one cell and that is configured by another base station.

Optionally, if the device is a base station, the transmitter 62 is configured to inform the user equipment (UE) of the VAM matrix information of the at least one cell by using physical layer signaling, where the physical layer signaling includes broadcast signaling or dedicated control signaling.

Optionally, if the base station is a serving base station, the at least one cell includes a serving cell and a neighboring cell of the UE; or if the base station is a neighboring base station, the at least one cell includes at least one cell covered by the neighboring base station.

Optionally, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

Optionally, the information for indicating a VAM matrix used by the cell includes one or more of the following information: identification information for indicating the VAM matrix; identification information for indicating a phase used by the VAM matrix; or identification information of the cell.

Optionally, the information for indicating a precoding codebook group used by the cell includes one or more of the following information: identification information of the precoding codebook group; information about the VAM matrix used to generate the precoding codebook group; or identification information of the cell.

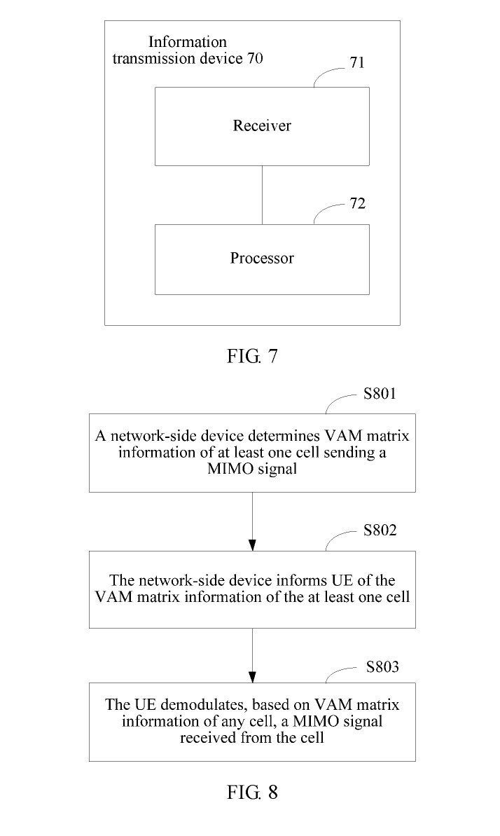

As shown in FIG. 7, FIG. 7 shows another information transmission device 70 according to an embodiment of the present application. The device may be UE, and includes: a receiver 71 and a processor 72.

The receiver 71 is configured to receive virtual antenna mapping (VAM) matrix information that is of at least one cell and that is sent from a network-side device, and transmit the received VAM matrix information of the at least one cell to a processor 72; and

The processor 72 is configured to demodulate, based on VAM matrix information of any one of the at least one cell, a multiple-input multiple-output (MIMO) signal received from the cell.

Optionally, if the device is a radio network controller (RNC), the receiver 71 is configured to receive the VAM matrix information that is of the at least one cell and that is sent from the RNC by using radio resource control (RRC) signaling.

Optionally, if the device is a base station, the receiver 71 is configured to receive the VAM matrix information that is of the at least one cell and that is sent from the base station by using physical layer signaling, where the physical layer signaling includes broadcast signaling or dedicated control signaling.

Optionally, if the base station is a serving base station, the at least one cell includes a serving cell and a neighboring cell of the UE; or if the base station is a neighboring base station, the at least one cell includes at least one cell covered by the neighboring base station.

Optionally, the VAM matrix information of each cell includes: information for indicating a VAM matrix used by the cell; or information for indicating a precoding codebook group used by the cell, where the precoding codebook group is a codebook set generated based on a VAM matrix and a precoding matrix set that can be used, and is used to demodulate a MIMO signal.

Optionally, the information for indicating a VAM matrix used by the cell includes one or more of the following information: identification information for indicating the VAM matrix; identification information for indicating a phase used by the VAM matrix; or identification information of the cell.

Optionally, the information for indicating a precoding codebook group used by the cell includes one or more of the following information: identification information of the precoding codebook group; information about the VAM matrix used to generate the precoding codebook group; or identification information of the cell.

As shown in FIG. 8, FIG. 8 is a flowchart of an information transmission method according to an embodiment of the present application. The information transmission method includes the following steps.

S801: A network-side device determines VAM matrix information of at least one cell sending a MIMO signal.

The at least one cell herein may include a serving cell and/or a neighboring cell of UE.

The network-side device herein may be a radio network controller (RNC) or a base station.

Based on different MIMO transmission manners, the VAM matrix information herein may be presented in two forms. The first form is information for directly indicating a VAM matrix used by the cell, and the other form is information for indicating a precoding codebook group used by the cell, where the precoding codebook group is a codebook set generated based on a VAM matrix and a precoding matrix set that can be used, and is used to demodulate a MIMO signal. The indication of the VAM matrix information is described in detail in the following Embodiment 2, and details are not described herein.

S802: The network-side device informs UE of the VAM matrix information of the at least one cell.

When the network-side device herein is a radio network controller (RNC), the RNC may inform the UE of the VAM matrix information of the at least one cell by using radio resource control (RRC) signaling. When the network-side device is a base station, the base station informs the UE of the VAM matrix information by using physical layer signaling, where the physical layer signaling includes broadcast signaling or dedicated control signaling.

S803: The UE demodulates, based on VAM matrix information of any one of the at least one cell, a MIMO signal received from the cell.

If the VAM matrix information herein indicates a specific VAM matrix, the UE may estimate a channel matrix based on the VAM matrix and demodulate a data stream signal based on the estimated channel matrix. If the VAM matrix information indicates a precoding codebook group, a data stream signal may be demodulated based on the precoding codebook group. For details, refer to descriptions in the following Embodiment 2.

A specific implementation process of this embodiment of the present application is described below by using an example in which the network-side device is a radio network controller (RNC).

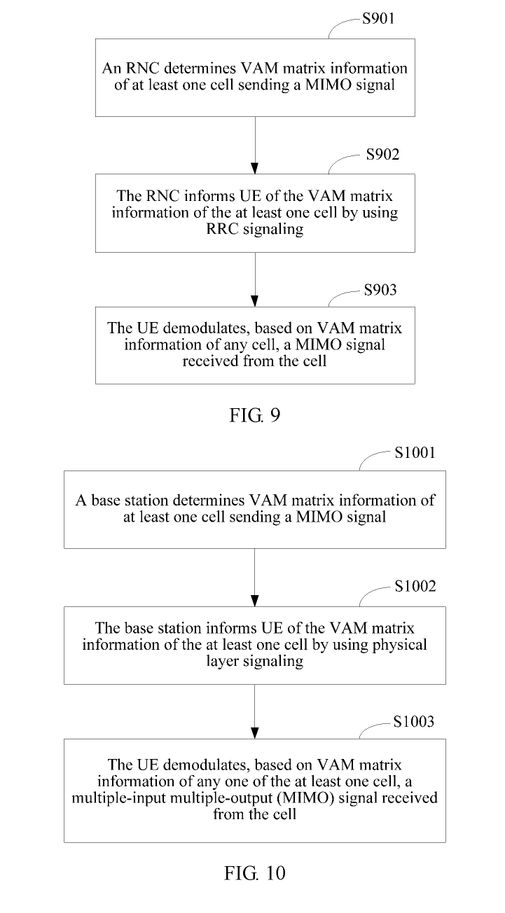

As shown in FIG. 9, FIG. 9 is a flowchart of an information transmission method according to another embodiment of the present application. The information transmission method includes the following steps.

S901: A radio network controller (RNC) determines VAM matrix information of at least one cell sending a MIMO signal.

That a radio network controller (RNC) determines VAM matrix information of at least one cell sending a MIMO signal may include one or both of the following two cases.

Case 1: The RNC determines VAM matrix information of a cell covered by at least one base station (NodeB) that is managed by the RNC.

In this case, the RNC may determine VAM matrix information of cells covered by some or all base stations that are managed by the RNC. In addition, the RNC may determine VAM matrix information of one or more cells (at least one cell) covered by each of the at least one base station that is managed by the RNC.

During specific implementation, the RNC may determine, in two manners, the VAM matrix information of the cell covered by the at least one base station that is managed by the RNC, and the two manners are respectively as follows.

Manner 1: The RNC receives the VAM matrix information that is of the cell and that is respectively sent from the at least one base station.

In this manner, a base station configures VAM matrix information of a cell covered by the base station and informs the RNC of the VAM matrix information.

Manner 2: The RNC respectively configures the VAM matrix information for the cell covered by the at least one base station that is managed by the RNC.

In this manner, the RNC respectively configures the VAM matrix information for the at least one cell covered by each of some or all base stations that are managed by the RNC.

During specific implementation, after the RNC configures the VAM matrix information for the cell, the RNC informs a base station to which the cell belongs of the VAM matrix information of the cell, so that the cell may obtain the VAM matrix information and perform MIMO transmission with UE by using the VAM matrix information.

Case 2: The RNC determines VAM matrix information of a cell covered by at least one base station that is managed by another RNC.

During specific implementation, the RNC may receive, by interacting with the another RNC, the VAM matrix information that is sent from the another RNC and that is of the cell covered by the base station that is managed by the another RNC.

S902: The RNC informs UE of the VAM matrix information of the at least one cell by using RRC signaling.

In this step, the RNC informs the UE of the determined VAM matrix information of the at least one cell by using the RRC signaling, so that the UE demodulates the received MIMO signal by using the VAM matrix information.

S903: The UE demodulates, based on VAM matrix information of any one of the at least one cell, a multiple-input multiple-output (MIMO) signal received from the cell.

During specific implementation, the UE may demodulate, by using VAM matrix information of a serving cell, a MIMO signal received from the serving cell. The UE may demodulate, by using VAM matrix information of a neighboring cell, a MIMO signal from the neighboring cell, so as to cancel or suppress interference from the neighboring cell.

Based on different MIMO transmission manners, the VAM matrix information in S901 to S903 may be presented in two manners.

Manner 1. Information for directly indicating a VAM matrix used by the cell.

The information for indicating a VAM matrix used by the cell may include one or more of the following information: identification information for indicating the VAM matrix; identification information for indicating a phase used by the VAM matrix; or identification information of the cell.

Among the foregoing information, the identification information of the cell is used to distinguish cells that correspond to different VAM matrices.

The identification information for indicating the VAM matrix may be identification information that can be used for distinguishing different VAM matrices, such as sequence numbers of VAM matrices. For example, N VAM matrices {S1, S2, . . . , Sn, . . . , SN} may be pre-defined, and the UE may learn a specific VAM matrix provided that the UE is informed of a sequence number n of the VAM matrix.

The identification information for indicating a phase used by the VAM matrix may be identification information for distinguishing different phases, such as a sequence number of the phase used by the VAM matrix. A detailed description is as follows.

In a 2×2 MIMO (that is, dual-input dual-output) transmission mode, the VAM matrix may be expressed as:

$$S = \frac{1}{\sqrt{2}} [ \begin{matrix}1 & {e}^{j ϕ} \\ {e}^{j θ} & - {e}^{j ( θ + ϕ )}\end{matrix} ]$$

It can be learned that the VAM matrix S may be determined by using a first phase φ and a second phase θ.

During specific implementation, N phase combinations {{φ₁,θ₁}, {φ₂,θ₂}, . . . , {φₙ,θₙ} . . . , {φ_{N},θ_{N}}} may be defined. The RNC informs the UE of a sequence number n of a selected phase combination, so that the UE may determine Sₙ. Alternatively, K first phase sequence numbers {φ₁, φ₂, . . . , φₖ . . . , φ_{K}} and J second phase sequence numbers {θ₁, θ₂, . . . , θⱼ . . . , θ_{J}} may be defined. The RNC informs the UE of a selected first phase sequence number k and a selected second phase sequence number j, so that the UE may determine S(φₖ,θⱼ).

That a MIMO signal is demodulated based on VAM matrix information is described below.

Assuming that a primary pilot signal is P₀, a secondary pilot signal is P₁, a data stream 1 signal is x₁, a data stream 2 signal is x₂, a VAM matrix is S, a matrix for precoding the data stream signals is B, where B is any matrix in a known precoding matrix group, and a channel matrix is H, received signals y₁ and y₂ that are on a UE side and that correspond to the transmitted primary pilot signal P₀ and secondary pilot signal P₁ may be expressed as:

$$[ \begin{matrix}{y}_{1} \\ {y}_{2}\end{matrix} ] = HS [ \begin{matrix}{P}_{0} \\ {P}_{1}\end{matrix} ] \qquad ( 1 )$$

It can be learned that the UE obtains HS based on the known received signals y₁ and y₂ and the known transmitted pilot signals P₀ and P₁. According to the foregoing solution described in this embodiment of the present application, the UE may learn the VAM matrix S, thereby solving the channel matrix H.

Received signals z₁ and z₂ that are on the UE side and that correspond to the data stream signals x₁ and x₂ may be expressed as:

$$\begin{matrix}[ \begin{matrix}{z}_{1} \\ {z}_{2}\end{matrix} ] = HB [ \begin{matrix}{x}_{1} \\ {x}_{2}\end{matrix} ] & ( 2 ) \\ [ \begin{matrix}{z}_{1} \\ {z}_{2}\end{matrix} ] = {HBx}_{1} & ( 3 )\end{matrix}$$

Formula (2) corresponds to two transmitted data stream signals, and formula (3) corresponds to one transmitted data stream signal. It can be learned that the UE may correctly demodulate the received signals z₁ and z₂ based on the solved channel matrix H and any matrix B of the known precoding matrix group.

Manner 2. Information for indicating a precoding codebook group used by the cell, where the precoding codebook group is a codebook set generated based on a VAM matrix and a precoding matrix set that can be used, and is used to demodulate a MIMO signal.

The information for indicating a precoding codebook group used by the cell may include one or more of the following information: identification information of the precoding codebook group; information about the VAM matrix used to generate the precoding codebook group; or identification information of the cell.

In this manner, pilot signals are also transmitted in the manner shown in formula (1). Data stream signals are respectively precoded by using S−1B and HS that can be estimated based on the pilot signals, as shown in the following formulas:

$$\begin{matrix}[ \begin{matrix}{z}_{1} \\ {z}_{2}\end{matrix} ] = {HSS}^{- 1} B [ \begin{matrix}{x}_{1} \\ {x}_{2}\end{matrix} ] & ( 4 ) \\ [ \begin{matrix}{z}_{1} \\ {z}_{2}\end{matrix} ] = {HSS}^{- 1} {Bx}_{1} & ( 5 )\end{matrix}$$

Formula (4) corresponds to two transmitted data stream signals, and formula (5) corresponds to one transmitted data stream signal. It can be learned that the UE may estimate HS based on the pilot signals. According to the foregoing solution described in this embodiment of the present application, the UE may learn the VAM matrix S, so that S−1B may be obtained. The UE may correctly model the received data stream signals based on S−1B and HS, thereby demodulating the received data stream signals.

In the foregoing formulas, S−1B is the precoding codebook group. During actual implementation, the RNC may inform the UE of a precoding codebook group S−1B used by a cell transmitting a MIMO signal. Each precoding codebook group is obtained by multiplying one S−1 by a group of B.

During specific implementation, N precoding codebook groups {S1−1B, S2−1B, . . . , Sn−1B, . . . , SN−1B} may be pre-defined, and the UE may learn a specific Sn−1B provided that the RNC informs the UE of a sequence number n of the precoding codebook group. In addition, because B in the precoding codebook group is a matrix in a specified matrix group, the RNC may inform the UE of only information about the VAM matrix S. In this case, the informed information about the VAM matrix may include the foregoing described identification information for indicating the VAM matrix, identification information for indicating a phase used by the VAM matrix, or the like.

That the network-side device is a serving cell and that the network-side device is a neighboring cell are respectively used as an example for description in the following Embodiment 3 and Embodiment 4. Any part during specific implementation of Embodiment 3 and Embodiment 4 that is the same as that of Embodiment 2, such as a presentation manner and usage of VAM matrix information, is not described again.

As shown in FIG. 10, FIG. 10 is a flowchart of an information transmission method according to still another embodiment of the present application. The information transmission method includes the following steps.

S1001: A base station determines VAM matrix information of at least one cell sending a MIMO signal.

The at least one cell herein includes a serving cell and/or at least one neighboring cell of UE.

Optionally, if the base station is a serving base station, the at least one cell may include a serving cell and a neighboring cell of the UE; or if the base station is a neighboring base station, the at least one cell may include at least one cell covered by the neighboring base station.

That is, the serving base station may send VAM matrix information of the serving cell of the UE to the UE, and may further send VAM matrix information of at least one neighboring cell of the UE to the UE. The at least one neighboring cell herein may be a cell covered by the serving base station, or may be a cell covered by a neighboring base station. In addition, the serving base station may send the VAM matrix information of the at least one cell to the UE by using the serving cell of the UE.

The neighboring base station may send VAM matrix information of only at least one cell covered by the neighboring base station to the UE. Certainly, the neighboring base station may send VAM matrix information that is of a cell covered by another base station and that is obtained by the neighboring base station to the UE. For example, the neighboring base station may send the VAM matrix information of the at least one cell to the UE by using one or more cells (neighboring cells of the UE) covered by the neighboring base station.

During specific implementation, the base station may obtain the VAM matrix information that is of the at least one cell and that is configured by a radio network controller (RNC). In this manner, the RNC configures VAM matrix information of a cell covered by at least one base station that is managed by the RNC, and may further receive VAM matrix information, of a cell, that is configured by another RNC and that is sent from the another RNC. The RNC sends the VAM matrix information configured by the RNC and/or the VAM matrix information sent from the another RNC to the at least one base station managed by the RNC.

Alternatively, the base station configures VAM matrix information for at least one cell covered by the base station, and obtains VAM matrix information that is of at least one cell and that is configured by another base station.

The base station may obtain the VAM matrix information that is of the at least one cell and that is configured by the another base station in the following manner: obtaining VAM matrix information that is of at least one cell covered by another base station and that is sent from a radio network controller (RNC). During specific implementation, any base station may report VAM matrix information that is of the at least one cell and that is configured by the base station to a corresponding RNC. The RNC may send the VAM matrix information that is of the at least one cell and that is configured by the any base station to another base station managed by the RNC, or send the VAM matrix information that is of the at least one cell and that is configured by the any base station to another RNC, and the another RNC sends the VAM matrix information to a base station managed by the another RNC.

S1002: The base station informs UE of the VAM matrix information of the at least one cell by using physical layer signaling.

The physical layer signaling herein may include broadcast signaling or dedicated control signaling. For example, the UE is informed of the VAM matrix information of the at least one cell by using a high speed shared control channel (HS-SCCH).

S1003: The UE demodulates, based on VAM matrix information of any one of the at least one cell, a multiple-input multiple-output (MIMO) signal received from the cell.

For example, if the at least one cell includes a serving cell, the UE demodulates, based on VAM matrix information of the serving cell, a MIMO signal received from the serving cell, or if the at least one cell includes a neighboring cell, the UE demodulates, based on VAM matrix information of the neighboring cell, a MIMO signal received from the neighboring cell.

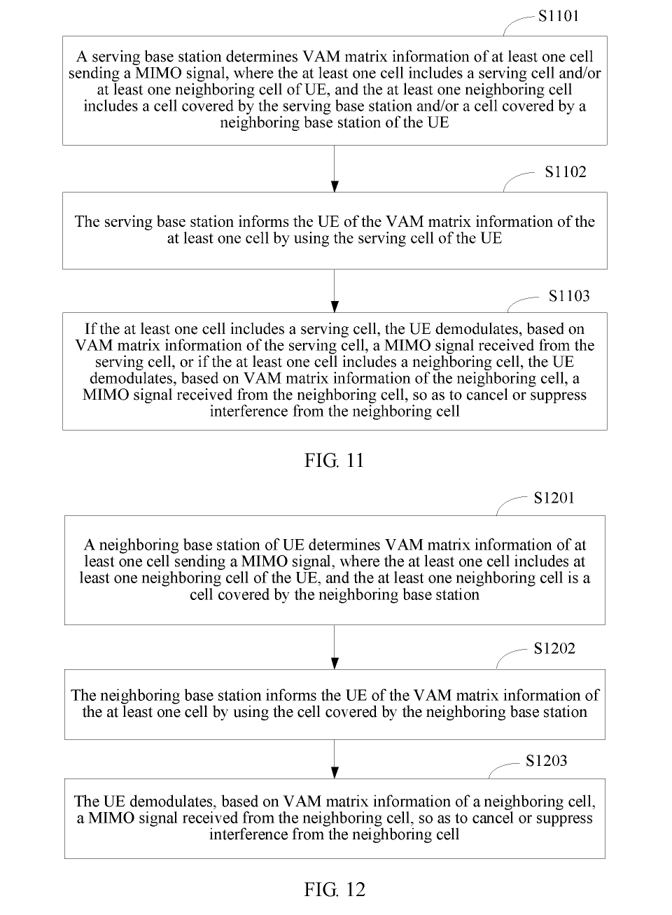

As shown in FIG. 11, FIG. 11 is a flowchart of an information transmission method according to yet another embodiment of the present application. The information transmission method includes the following steps.

S1101: A serving base station determines VAM matrix information of at least one cell sending a MIMO signal, where the at least one cell includes a serving cell and/or at least one neighboring cell of UE, and the at least one neighboring cell includes a cell covered by the serving base station and/or a cell covered by a neighboring base station of the UE.

S1102: The serving base station informs the UE of the VAM matrix information of the at least one cell by using the serving cell of the UE.

S1103: If the at least one cell includes a serving cell, the UE demodulates, based on VAM matrix information of the serving cell, a MIMO signal received from the serving cell, or if the at least one cell includes a neighboring cell, the UE demodulates, based on VAM matrix information of the neighboring cell, a MIMO signal received from the neighboring cell, so as to cancel or suppress interference from the neighboring cell.

As shown in FIG. 12, FIG. 12 is a flowchart of an information transmission method according to still yet another embodiment of the present application. The information transmission method includes the following steps.

S1201: A neighboring base station of UE determines VAM matrix information of at least one cell sending a MIMO signal, where the at least one cell includes at least one neighboring cell of the UE, and the at least one neighboring cell is a cell covered by the neighboring base station.

S1202: The neighboring base station informs the UE of the VAM matrix information of the at least one cell by using the cell covered by the neighboring base station.

The neighboring base station herein may inform the UE of the VAM matrix information of the at least one cell by using the cell covered by the neighboring base station, or may inform the UE of VAM matrix information of each of the at least one cell by using the cell.

S1203: The UE demodulates, based on VAM matrix information of a neighboring cell, a MIMO signal received from the neighboring cell, so as to cancel or suppress interference from the neighboring cell.

A person skilled in the art should understand that the embodiments of the present application may be provided as a method, a system, or a computer program product. Therefore, the present application may use a form of hardware only embodiments, software only embodiments, or embodiments with a combination of software and hardware. Moreover, the present application may use a form of a computer program product that is implemented on one or more computer-usable storage media (including but not limited to a disk memory, a CD-ROM, an optical memory, and the like) that include computer-usable program code.

The present application is described with reference to the flowcharts and/or block diagrams of the method, the apparatus (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some embodiments of the present application have been described, a person skilled in the art can make changes and modifications to these embodiments once they learn the basic inventive concept. Therefore, the following claims are intended to be construed as to cover the preferred embodiments and all changes and modifications falling within the scope of the present application.

Obviously, a person skilled in the art can make various modifications and variations to the present application without departing from scope of the present application. The present application is intended to cover these modifications and variations provided that they fall within the scope of protection defined by the following claims and their equivalent technologies.

What is claimed is:

1. An information transmission device, wherein the device comprises:
a processor, configured to determine virtual antenna mapping (VAM) matrix information of at least one cell sending a multiple-input multiple-output (MIMO) signal; and
a transmitter, configured to inform user equipment (UE) of the VAM matrix information of the at least one cell.

2. The device according to claim 1, wherein if the device is a radio network controller (RNC), the processor is configured to implement at least one of:
determining VAM matrix information of a cell covered by at least one base station that is managed by the RNC; or
determining VAM matrix information of a cell covered by at least one base station that is managed by another RNC.

3. The device according to claim 2, wherein the processor is configured to determine the VAM matrix information of the cell covered by the at least one base station that is managed by the RNC by:
determining the VAM matrix information that is of the cell and that is respectively sent from the at least one base station to the RNC; or
respectively configuring the VAM matrix information for the cell covered by the at least one base station that is managed by the RNC.

4. The device according to claim 3, wherein the transmitter is further configured to:
after the processor respectively configures the VAM matrix information for the cell covered by the at least one base station that is managed by the RNC, send the VAM matrix information configured for each cell to a base station to which the cell belongs.

5. The device according to claim 2, wherein the processor is configured to determine the VAM matrix information of the cell covered by the at least one base station that is managed by the another RNC by determining the VAM matrix information that is of the cell and that is sent from the another RNC.

6. The device according to claim 1, wherein if the device is a radio network controller (RNC), the transmitter is configured to inform the UE of the VAM matrix information of the at least one cell by using radio resource control (RRC) signaling.

7. The device according to claim 1, wherein if the device is a base station, the processor is configured to implement at least one of:
obtaining the VAM matrix information that is of the at least one cell and that is configured by a radio network controller (RNC); or
configuring VAM matrix information for at least one cell covered by the base station, and obtain VAM matrix information that is of at least one cell and that is configured by another base station.

8. The device according to claim 1 wherein if the device is a base station, the transmitter is configured to inform the user equipment (UE) of the VAM matrix information of the at least one cell by using physical layer signaling, wherein the physical layer signaling comprises broadcast signaling or dedicated control signaling.

9. The device according to claim 8, wherein if the base station is a serving base station, the at least one cell comprises a serving cell and a neighboring cell of the UE; or if the base station is a neighboring base station, the at least one cell comprises at least one cell covered by the neighboring base station.

10. The device according to claim 1, wherein the VAM matrix information of each cell comprises:
information for indicating a VAM matrix used by the cell; or
information for indicating a precoding codebook group used by the cell, wherein the precoding codebook group is a codebook set generated based on a VAM matrix and a precoding matrix set that can be used, and is used to demodulate a MIMO signal.

11. The device according to claim 10, wherein the information for indicating a VAM matrix used by the cell comprises one or more of the following information:
identification information for indicating the VAM matrix;
identification information for indicating a phase used by the VAM matrix; or
identification information of the cell.

12. The device according to claim 10, wherein the information for indicating a precoding codebook group used by the cell comprises one or more of the following information:
identification information of the precoding codebook group;
information about the VAM matrix used to generate the precoding codebook group; or
identification information of the cell.

13. An information transmission device, wherein the device comprises:
a receiver, configured to receive virtual antenna mapping (VAM) matrix information that is of at least one cell and that is sent from a network-side device; and
a processor, configured to demodulate, based on VAM matrix information of any one of the at least one cell, a multiple-input multiple-output (MIMO) signal received from the cell.

14. The device according to claim 13, wherein if the device is a radio network controller (RNC), the receiver is configured to receive the VAM matrix information that is of the at least one cell and that is sent from the RNC by using radio resource control (RRC) signaling.

15. The device according to claim 13, wherein if the device is a base station, the receiver is configured to receive the VAM matrix information that is of the at least one cell and that is sent from the base station by using physical layer signaling, wherein the physical layer signaling comprises broadcast signaling or dedicated control signaling.

16. The device according to claim 15, wherein if the base station is a serving base station, the at least one cell comprises a serving cell and a neighboring cell of user equipment (UE); or if the base station is a neighboring base station, the at least one cell comprises at least one cell covered by the neighboring base station.

17. The device according to claim 13, wherein the VAM matrix information of each cell comprises:
information for indicating a VAM matrix used by the cell; or
information for indicating a precoding codebook group used by the cell, wherein the precoding codebook group is a codebook set generated based on a VAM matrix and a precoding matrix set that can be used, and is used to demodulate a MIMO signal.

18. The device according to claim 17, wherein the information for indicating a VAM matrix used by the cell comprises one or more of the following information:
identification information for indicating the VAM matrix;
identification information for indicating a phase used by the VAM matrix; or
identification information of the cell.

19. The device according to claim 17, wherein the information for indicating a precoding codebook group used by the cell comprises one or more of the following information:
identification information of the precoding codebook group;
information about the VAM matrix used to generate the precoding codebook group; or
identification information of the cell.

20. An information transmission method, wherein the method comprises:
receiving, by user equipment (UE), virtual antenna mapping (VAM) matrix information that is of at least one cell and that is sent from a network-side device; and
demodulating, by the UE, based on VAM matrix information of any one of the at least one cell, a multiple-input multiple-output (MIMO) signal received from the cell.
